(19) United States
(12) Patent Application Publication
(10) Pub. No.: US 2016/0317990 A1
(43) Pub. Date: Nov. 3, 2016

(54) GEOMETRY OF A CATALYTIC REACTOR COMBINING GOOD MECHANICAL STRENGTH AND GOOD FLUID DISTRIBUTION

(71) Applicants: L'AIR LIQUIDE, SOCIETE ANONYME POUR L'ETUDE ET L'EXPLOITATION DES PROCEDES GEORGES CLAUDE, Paris (FR); CENTER NATIONAL DE LA RECHERHE SCIENTIFIQUE, Paris Cedex (FR); UNIVERSITE DE LORRAINE, Nancy Cedex (FR); FIVES CRYO, Goldey Cedex (FR)

(72) Inventors: Solene VALENTIN, Meudon (FR); Laurent PROST, Gif Sur Yvette (FR); Olivier DUBET, Buc (FR); Matthieu FLIN, Paris (FR); Jean-Marc COMMENGE, Nancy (FR); Guislain GENIN, Laxou (FR); Laurent FALK, Bioncourt (FR); Johan DIB, Igney (FR); Thierry MAZET, Nancy (FR)

(73) Assignees: L'Air Liquide, Societe Anonyme pour l'Etude et l'Exploitation des Procedes Georges Claude, Paris (FR); Centre National De La Recherche Scientifique, Paris cedex (FR); Universite De Lorraiine, Nancy Cedex (FR); Fives Cryo, Golbey cedex (FR)

(21) Appl. No.: 15/106,110

(22) PCT Filed: Dec. 4, 2014
(86) PCT No.: PCT/FR2014/053170

§ 371 Date: Jun. 17, 2016

(30) Foreign Application Priority Data
Dec. 19, 2013 (FR) 1362947

(51) Int. Cl. B01J 7/02; C01B 3/38; B01J 19/00

(52) U.S. Cl. CPC B01J 7/02; B01J 19/0093; C01B 3/38; B01J 2219/00783; B01J 2219/00835; B01J 2219/0086; B01J 2219/00873; C01B 2203/0233; C01B 2203/1241

(57) ABSTRACT

The invention relates to a compact catalytic reactor comprising at least three plates with at least one area of millimetric channels on each plate, promoting heat exchange, and at least one distribution area upstream and/or downstream of the area of millimetric channels, the channels being separated by walls. The distribution areas are characterized by:

the discontinuity of the walls along the distribution area on the side of the inflow of gaseous flows or on the side of the outflow thereof; and

the increase in the width of the walls along the distribution area on the side of the inflow of gaseous flows or on the side of the outflow thereof.

### CROSS-REFERENCE TO RELATED APPLICATIONS

This application is a §371 of International PCT Application PCT/FR2014/053170, filed Dec. 4, 2014, which claims §119(a) foreign priority to French patent application FR1362947, filed Dec. 19, 2013.

### BACKGROUND

1 Field of the Invention

The present invention relates to the geometry of a catalytic reactor for the production of syngas.

2. Related Art

The most common process for producing syngas is steam reforming of methane. This reaction is catalytic and endothermic. Industrially, this reaction is carried out in a fixed bed in catalyst-filled tubes. In order to provide the heat necessary for the reaction, these tubes are placed in a furnace. The energy necessary for the reaction is thus obtained by combustion and is transmitted to the tubes mainly by radiation. The syngas is therefore obtained at high temperature, generally between 750° C. and 950° C. An already very common optimization proposes carrying out the reaction in a compact reactor in order to reduce the thermal energy consumed by the combustion. A compact reactor is a reactor where the exchanges of matter and of heat are intensified owing to a geometry where the characteristic dimensions such as hydraulic diameter are of the order of a millimeter. The compact reactors proposed for the production of syngas are composed of a multitude of millimetric passages, referred to as “channels”, which are formed by means of “walls”. Subsequently, the term “wall” will be understood to mean a partition between two consecutive channels. These channels are distributed over plates. The plates are then assembled in order to form the micro reactor. The walls therefore also make it possible to connect two plates of the reactor together and therefore have a direct influence on the mechanical strength of the equipment. One of the problems with the use of this type of equipment is the distribution of fluids at the inlet of the reactor. Indeed, in order to treat an industrial flow of fluids, a multitude of millimetric passages is necessary. A poor distribution of the fluids at the inlet has a detrimental influence on the heat transfer, on the uniformity of the deposition of catalyst (coating deposition method), on the conversion, etc. The creation of the distribution area is therefore a key step in the design of this type of exchange-reactor; it must both ensure a homogeneous distribution of the fluids in all the channels while having a structure that remains compatible with the significant mechanical stresses undergone by the equipment. Finally, it is important to indicate that a poor distribution accentuates the thermal gradients over the exchanger-reactor thus increasing the mechanical stresses thereon, which may reduce its service life.

Solutions for having the best homogeneity of distribution of fluids in the alignment of the channels include a wall-free distribution area. However, the mechanical strength of the assembly of such a distribution area is not strong. As regards the application to the process for producing syngas, the pressure difference between each plate may be greater than 15 bar and the temperature in the distribution area is at most 650° C. The “simplest” solution for reinforcing the mechanical strength of the whole assembly in the distribution area consists in adding simple walls the same dimension as in the area of millimetric channels and forming an angle with the channels (as in the example from FIG. 1: Example of architecture of a distribution chamber with “straight” walls).

Although this geometry of the distributor makes it possible to reinforce the mechanical strength of the exchanger-reactor in the distribution area, the performance in terms of fluid distribution is debatable:
the excessively severe narrowings lead to the existence of pressure gradients between the channels,
since the walls are continuous between the distribution area and the channels, the pressures of the channels cannot be rebalanced,
this results in significant differences in fluid velocities in the channels and therefore a non-homogeneous distribution of the fluids in the channels.

These two examples have made it possible to illustrate the challenges and difficulties associated with the design of the distribution area of exchanger-reactors. Thus, the distribution area must allow a uniform distribution of the fluids in the channels while offering high contact areas in order to ensure the mechanical strength of the whole of the structured block. Finally, the relative length of these chambers with respect to the plates must be optimized in order to minimize the size thereof and to maximize the length of the straight channels, which makes it possible to optimize the production costs of the reactor.

Starting from there, one problem that is faced is to provide a catalytic reactor having both a good mechanical strength and a homogeneous distribution of fluids.

### SUMMARY OF THE INVENTION

The solution of the present invention is a compact catalytic reactor comprising at least 3 plates with, on each plate, at least one area of millimetric channels promoting heat exchanges and at least one distribution area upstream and/or downstream of the area of millimetric channels; the channels being separated by walls, the distribution areas are characterized by:
the discontinuity of the walls along the distribution area on the gas stream inlet side or outlet side; and
the increase in the width of the walls along the distribution area on the gas stream inlet side or outlet side.

The present invention relates particularly to the distribution areas of the compact catalytic reactor. The architecture of the distribution chambers is based on a “fan-shaped” progressive dichotomous arborescent structure (see FIG. 2).

It should be noted that:
the discontinuity of the walls along the distribution area on the gas stream inlet side or outlet side enables a rebalancing of the pressures between the channels, and
the increase in the width of the walls along the distribution area on approaching the inlet or outlet of the gas streams makes it possible to increase the contact area between the plates and therefore to increase the mechanical strength.

Depending on the case, the reactor according to the invention may have one or more of the following features:
the walls near the inlet or the outlet of the gas streams are of oblong shape and have an increase in their widths in the direction of the area of millimetric channels; it should be noted that this oblong shape makes it possible to avoid the existence, locally, of high velocities of the gas stream;
the width of the wall to width of the channel ratio of the walls of oblong shape is greater than or equal to the width of the wall to width of the channel ratio of the walls of the area of millimetric channels;
the length of the distribution area represents at most ⅓ of the plate;
said reactor comprises at least one first plate comprising at least one distribution area and at least one area of millimetric channels in order to circulate a gas stream at a temperature at least above 700° C. so that it provides a portion of the heat necessary for the catalytic reaction; at least one second plate comprising at least one distribution area and at least one area of millimetric channels in order to circulate a reactive gas stream in the direction of the length of the catalyst-covered millimetric channels in order to react the gas stream; at least one third plate comprising at least one distribution area and at least one area of millimetric channels in order to circulate the gas stream produced on the second plate so that it provides a portion of the heat necessary for the catalytic reaction; with, on the second plate and the third plate, a system so that the gas stream produced can circulate from the second plate to the third plate.

The catalytic reaction may be a methane steam reforming reaction.

It should be noted that the increase in the number of walls between channels on approaching the area of millimetric channels enables both a good circulation of the fluid while ensuring a good contact area with the upper plate for the assembly requirements.

### BRIEF DESCRIPTION OF THE FIGURES

FIG. 1 is an example of a distribution chamber architecture with “straight” walls.

FIG. 2 is schematic of an aspect of the invention directed to a distribution chamber architecture based on a “fan-shaped” progressive dichotomous arborescent structure.

FIG. 3 is an example of a distribution chamber with straight walls.

FIG. 4 is an example of a distribution chamber according to the invention.

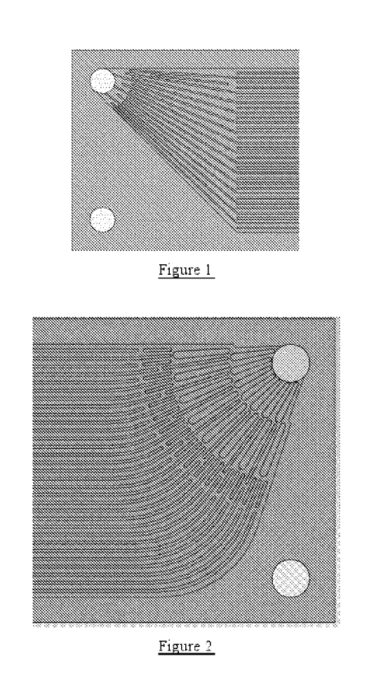

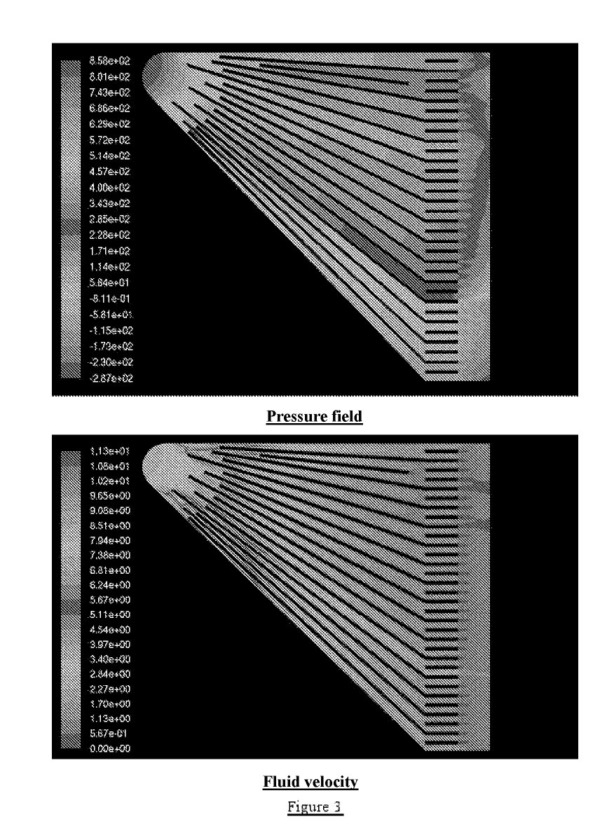

### DETAILED DESCRIPTION OF THE INVENTION

Another subject of the present invention is a process for producing syngas using a catalytic reactor according to the invention.

An example of a compact catalytic reactor according to the invention is described below.

The elementary module is composed of two first plates where a hot gas circulates in order to provide the heat necessary for the reaction. Placed between these two first plates are two second plates that are covered with catalysts and that are where the reaction takes place. Placed between these two second plates is a third plate where the syngas produced circulates while providing heat to the reaction. Holes are placed at the end of this last plate and at the end of the highest of the reactive plates to allow the syngas produced to pass from the “reactive” plates to the third plate. The hot gas that provides the heat necessary for the reaction is produced by combustion.

The homogeneous distribution of the reactants and of the combustion gases at the inlet of the microreactor is important for increasing the heat transfer between the reactants and the combustion gases. The geometry of the plates of the elementary module described is therefore characterized by:
millimetric channels that merge into a limited number of channels over at least ¼ of the length of the plate on the gas stream distribution side,
over the ¼ of the length of the plate where the millimetric channels merge, the number of millimetric channels is divided a first time by 2 then a second time by 2 before reaching the feed gas stream inlet,
over at least ¾ of the length of the plate the millimetric channels are rectilinear and parallel,
over at least ¼ of the length of the plate on the gas stream distribution side the walls are of oblong shape with the end on the gas stream inlet or outlet side being narrower,
over at least ¼ of the length of the plate on the gas stream distribution side the width of the walls/width of the channels ratio is greater than or equal to the width of the walls/width of the channels ratio measured on the remaining ¾ of the second plate.

The present invention proposes an architecture of the distribution area of the plates that makes it possible:
to ensure a homogeneous distribution of the fluids in all the channels of the exchanger-reactor,
to enable homogeneous deposition of the catalyst on the reactive plates during the coating phase,
to intensify the heat transfer,
to obtain the mechanical strength necessary for the high-pressure and high-temperature operating conditions.

The homogeneity of distribution of the reactive gases is ensured by the discontinuity of the walls which forms areas for mixing the gas between the channels and the rebalancing of the driving pressures. The same architecture is imposed on the inlet and the outlet and this symmetry also improves the uniformity of the flow.

The increase in the width of the walls and the oblong shape with an increase in the width of the wall along the latter at the inlet and at the outlet of the gases ensures a homogeneity in mechanical strength. The tensile stress in the wall is caused by the pressure in the channel (space between two adjacent walls). Since the ratio of the wall/channel widths remains greater than or equal to that of the area of the straight channels, a homogeneity in mechanical strength is then ensured. Furthermore, the oblong shape of the walls increases the contact area between two plates which makes it possible to improve the assembly of the plates and the mechanical strength of the whole assembly.

Thus, the innovative architecture of the distribution areas set out above was determined in order to ensure a uniform distribution of the fluids in the channels and also a good mechanical strength of the exchanger-reactor. It is possible to illustrate the performance of this particular architecture by the results of a numerical fluid mechanics simulation for the “reactive” plates with the architecture with straight walls and the architecture with a “fan-shaped” progressive dichotomous arborescent structure according to the invention.

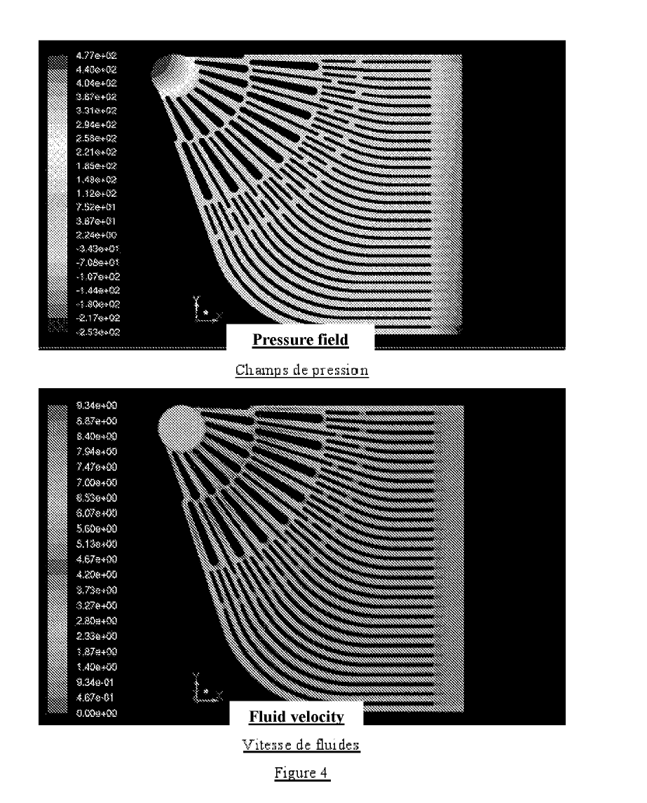

In FIG. 3 (example of distribution chamber with straight walls; pressure field (at the top) and fluid velocity (at the bottom)), it is possible to see the existence of pressure gradients between the various channels and also differences in fluid flow velocity in the channels. This results in a poor distribution of the fluid in the channels which will degrade the performance of the equipment. In FIG. 4 (example of distribution chamber according to the invention; pressure field (at the top) and fluid velocity (at the bottom)), where the distribution chamber was designed according to the invention, it is possible to observe a practically homogeneous distribution of the fluid flow rates in the channels.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step. The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”,

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur. Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-6. (canceled)

7. A compact catalytic reactor comprising at least 3 plates with, on each plate, at least one area of millimetric channels promoting heat exchanges and at least one distribution area upstream and/or downstream of the area of millimetric channels; the channels being separated by walls, the distribution areas are characterized by:
a continuity of the channels between the distribution area and the area of millimetric channels promoting the heat exchanges;
a discontinuity of the walls along the distribution area on a gas stream inlet side or a gas stream outlet side; and
an increase in the width of the walls along the distribution area on the gas stream inlet side or outlet side.

8. The compact catalytic reactor of claim 7, wherein the walls near the inlet or the outlet of the gas streams are of oblong shape and have an increase in their widths in the direction of the area of millimetric channels.

9. The compact catalytic reactor of claim 8, wherein a ratio of a width of the oblong shape walls to a width of the channels is greater than or equal to a ratio of a width of the wall, of the area of millimetric channels, to a width of the channels.

10. The compact catalytic reactor of claim 7, wherein a length of the distribution area represents at most ⅓ of the plate.

11. The compact catalytic reactor of claim 7, wherein said at least 3 plates comprises:
at least one first plate comprising at least one distribution area and at least one area of millimetric channels in order to circulate a gas stream at a temperature at least above 700° C. so that it provides a portion of the heat necessary for the catalytic reaction,
at least one second plate comprising at least one distribution area and at least one area of millimetric channels in order to circulate a reactive gas stream in the direction of the length of the catalyst-covered millimetric channels in order to react the gas stream, and
at least one third plate comprising at least one distribution area and at least one area of millimetric channels in order to circulate the gas stream produced on the second plate so that it provides a portion of the heat necessary for the catalytic reaction; with, on the second plate and the third plate, a system so that the gas stream produced can circulate from the second plate to the third plate.

12. A process for producing syngas, comprising using the catalytic reactor of claim 7.
